(19) United States
(12) Patent Application Publication
(10) Pub. No.: US 2002/0087676 A1
(43) Pub. Date: Jul. 4, 2002

(54) System and method of charging for a servce produced in a communication network and corresponding application software and/or hardware

(76) Inventors: Gero Baese, Muenchen (DE); Martin Gebler, Pulach im Isartal (DE); Sabine Markgraf, Gauting (DE); Annette Schlossnikel, Muenchen (DE); Thomas Strobel, Gauting (DE); Juergen Wilde, Taufkirchen (DE); Andre Fischer, Berlin (DE); Peter Moritz, Haar (DE); Stefan Prange, Muenchen (DE); Arnd Sibila, Moorenweis (DE); Christian Von Brockdorff, Icking (DE)

Correspondence Address: Kevin R. Spivak, Morrison & Foester LLP, 2000 Pennsylvania Ave., N.W., Washington, DC, 20006-1888, US

(21) Appl. No.: 09/962,797

(22) Filed: Sep. 26, 2001

(30) Foreign Application Priority Data
Sep. 26, 2000 (DE) 10047595.7
Mar. 26, 2001 (DE) 10115744.4

(51) Int. Cl. G06F 15/173

(52) U.S. Cl. 709/223; 709/229

(57) ABSTRACT

The present invention relates to a system and method of charging for a service produced in a communication network, the service and the charging for the service being produced and performed, respectively, by means of application software and/or hardware on a communication unit of a subscriber of the communication network. The invention also provides an application software and/or hardware, which can be integrated into a communication network and by means of which at least one service can be produced and charging for this service produced can be performed.

### CLAIM FOR PRIORITY

This application claims priority to German Applications 10047595.7 and 10115744.2 filed Sept. 26, 2000 and Mar. 26, 2001, respectively, the contents of which are hereby incorporated by reference.

### TECHNICAL FIELD OF THE INVENTION

The present invention relates to a system and method of charging for a service produced in a communication network, and in particular, to an application software and/or hardware which can be used to produce the service and to charge for it.

### BACKGROUND OF THE INVENTION

Generally, services provided in and by a communication network are produced and controlled by a central unit of an intelligent network (IN), when demanded by a subscriber of the network. The communication network subscriber wishing to use one or more specific service must first be registered, or have subscribed, in a central unit of the intelligent network. An intelligent network typically includes an intelligent node which centrally monitors and controls the sequences in the communication network. The information required for charging for a service (i.e. the cost) produced by the intelligent network is likewise captured by the intelligent network in a central memory unit assigned to the intelligent network, and forwarded for further processing to an accounting unit provided for assessing charges in the communication network.

The services which can be provided or produced in a communication network by means of an intelligent network can be produced identically and in the same way for all authorized, i.e. registered, subscribers of the communication network.

### SUMMARY OF THE INVENTION

In one embodiment of the invention, there is a method of charging for a service produced in a communication network. The method includes, for example, servicing and charging for the service being produced and performed, respectively, using at least one of application software and hardware on a communication unit of a subscriber of the communication network.

In one aspect of the invention, the service is produced in a subscriber-specific manner.

In another aspect of the invention, charging for the service is effected in a service-related or service-conforming manner.

In still another aspect of the invention, the communication unit is a communication terminal for a mobile communication device.

In another embodiment of the invention, there is a computer readable medium having application software stored thereon. The invention includes, for example, servicing and charging at least one service to be produced and performed, respectively, such that the program is configured to be integrated into a communication network.

In one aspect of the invention, the software can be installed on a communication unit of a subscriber of the communication network.

In another aspect of the invention, the communication unit is a communication terminal for a mobile communication device.

In still another aspect of the invention, the charging can be performed in a service-related manner.

In yet another aspect of the invention, the service can be produced specifically for a communication network subscriber.

In still another embodiment of the invention, there is a system including, for example, hardware to service and charge at least one service to be produced and performed, respectively, such that the hardware is configured to be integrated into a communication network.

In still another embodiment of the invention, there is a communication network system. The system includes, for example, at least one of application software and hardware to service and charge at least one service to be produced and performed, respectively, such that at least the application software and hardware are configured to be integrated into a communication network, wherein the software and hardware are configured for installation on a communication unit of a subscriber of the communication network, the communication unit is a communication terminal for a mobile communication device, the charging can be performed in a service-related manner, and the service can be produced specifically for a communication network subscriber.

### BRIEF DESCRIPTION OF THE DRAWINGS

FIG. 1 shows an embodiment of a network system according to the invention.

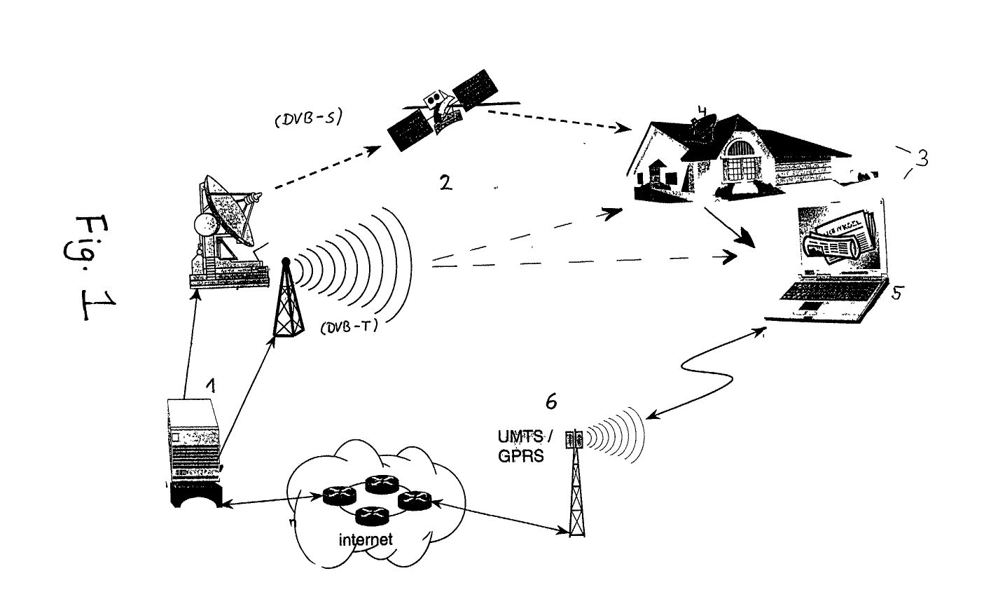

FIG. 2 illustrates a flow diagram of an embodiment of the invention.

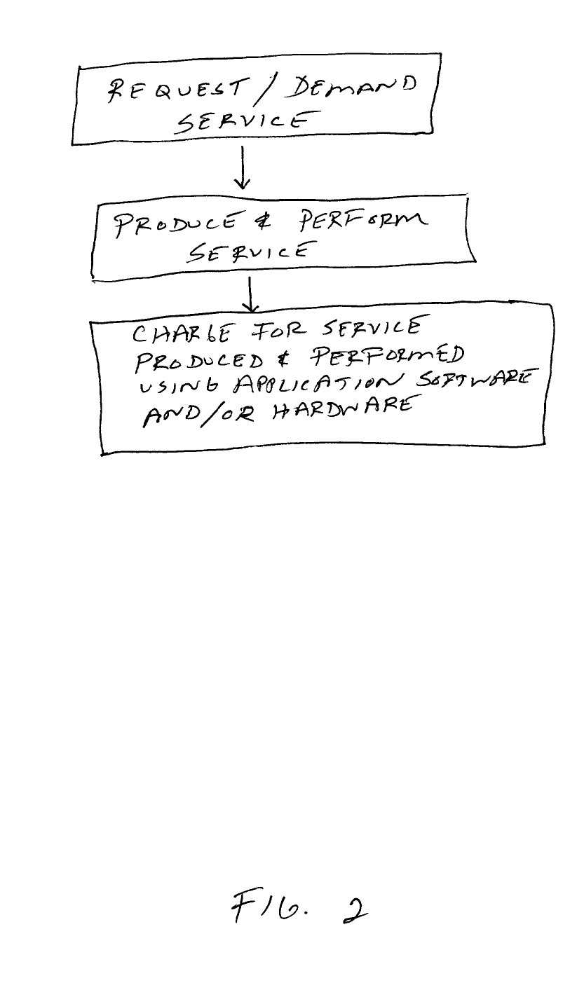

### DETAILED DESCRIPTION OF THE PREFERRED EMBODIMENTS

The present invention provides a method which can be used to produce subscriber-specific services and to charge for these services on site, i.e. directly at the site of the services produced.

The method of charging for a service produced in a communication network is produced and performed by means of an application software and/or hardware on a communication unit of a subscriber of the communication network.

In a preferred embodiment of the method, the service is produced in a subscriber-specific manner. That is, each subscriber authorized to demand a service of this type, i.e. each subscriber provided with a corresponding application software and/or hardware, can coordinate the service to be produced by the application software and/or hardware with his/her individual requirements.

In a preferred embodiment of the invention, the service to be produced by the application software and/or hardware includes individualized information from a total amount of information. The total amount of information may be, for example, a collection of press information from different publishers, agencies or other information sources. Personalization or individualization of information has hitherto been possible only according to very rough classifications. This rough classification has generally taken place in a central station, from which only a small individual data stream has then been transmitted to the corresponding subscriber. In the case of television, for example, advertisers are able to personalize advertisements to a select group of viewers, but not to select individuals. The groups may be selected, for example, according to the viewing public and the type of show presently being viewed. However, the programming and corresponding advertisements do not specifically address the individual subscriber. Hence, information in this respect is not personalized in the same manner as the invention. Personalization in the context of the present invention includes contents or items of information that are desired by a subscriber and are personally tailored to him/her and are communicated to the subscriber or provided for him/her. The application software and/or hardware provided enables the subscriber(s) of the network to individually select and store information from the total amount of information, and preferably also to print it out on a compatible printer. In this case, the selection of information from the total amount of information can be changed by the subscriber at any time via the application software and/or hardware provided according to the invention, including dynamic changes. The total amount of information can be stored as complete “raw information” and subsequently be processed, although this requires a large amount of memory space. Alternatively, it can be filtered “on the fly”, i.e. during the actual process of transmission, with the result that only the personalized information, preferably with adjacent information for possible demand, is stored and correspondingly prepared, i.e. printed out or loaded onto a suitable communication unit, preferably onto a communication terminal or display device.

Individualization or personalization of the information from the total amount of information can be effected in different ways. First, the network subscriber can perform individualization with respect to contents, i.e. he/she can make the selection according to subject areas, such as sports, business, stock market, culture, features, gossip or advertisements. It is also possible to select more specifically according to subject areas, for example to select in a targeted manner only information on the Neuen Markt Frankfurt, only information specific to Formula 1, or only business information relating to communications technology. Additionally, the invention enables the network subscriber(s) to determine the form in which the information he/she has selected is to be presented, or the detail with which an item of information is to be communicated. He/She can decide to receive only headings or only headings with the first paragraph or complete articles.

In a preferred embodiment, the charging (i.e. cost) of the service produced by the application software and/or hardware provided according to the invention is performed by the same application software and/or hardware. In this case, cost is preferably determined based on a service-related or service-conforming manner. For example, depending on the complexity of the service produced, a corresponding fee is charged to the communication network subscriber requesting the service. When the service produced is, for example, individualized information specified by the subscriber, the cost associated with it depends on the degree of detail requested in the individualized information. The more complicated or specific the request, the more difficult it is to filter out the desired information from the total amount of information. Hence, the higher the payable charge (cost). That is, in addition to the service produced, charges are effected in a subscriber-specific manner.

In contrast to the production of a service, which can preferably be controlled by a subscriber in a correspondingly independent manner by the application software and/or hardware provided, the charges for this service should preferably not be manipulated by the subscriber demanding the corresponding service. In this case, it is preferable for the charges for a service to be fixed in the front end by a provider of the corresponding service or by the operator of the communication network and effected automatically. In this case, it would be possible, for example, to first levy a basic amount or a basic charge for the lowest level of individualization of information. The lowest level might, for example, be a straightforward selection of subjects from the total amount of information. For example, the selection of business, sports or politics in each case as a whole. Requests with more specificity could have a surcharge applied. Additional further-specificity of information could include making a specific selection within a subject, such as business or sports, for example only stock market information on the “Neuen Markt” or Formula 1 news. Moreover, a further surcharge could be levied if a specific form of presentation is desired, i.e. no complete articles, but rather, for example, only headings or headings with introductory paragraphs.

In another preferred embodiment of the method according to the invention, the communication unit of the subscriber (on which a corresponding service is produced by means of the application software and/or hardware provided) is a communication terminal, preferably a mobile communication device, such as a mobile radio device, a laptop or a SIMPAD. However, a printer unit may also be used to print out the individualized information.

Additionally, the present invention provides an application software and/or hardware by means of which a service can be produced and charges for the service can be performed. In the case of a hardware, a so-called “digital video broadcast plug-in card” can be used, for example.

In a preferred embodiment of the application software and/or hardware according to the invention, the latter can be installed on a communication unit of a subscriber of the communication network. This results in the subscriber using the application software and/or hardware easily to produce a service that is desired. The communication unit is preferably a communication terminal, in particular a mobile communication device, such as a mobile radio device, a laptop or a SIMPAD. As a result, the subscriber of the communication network is able to request and demand services even on the move.

In another preferred embodiment of the application software and/or hardware according to the invention, the charges that are performed for the service produced is service-related or service-conforming. If the service requires comparatively high complexity, then the corresponding charge imposed on the communication network subscriber demanding the service should also be high, and vice versa. If, by way of example, individualized information from the total amount of information is involved, then the charge is dependent on the degree of individualization, e.g. the higher the degree of detail and/or complexity of the information to be filtered from the total amount of information, the more complex the service is, and, hence, the service is charged at a correspondingly high level.

Additionally, the specified service can be produced specifically for a communication network subscriber demanding said service by the application software and/or hardware. That is, the subscriber himself/herself can coordinate and tailor the service he/she desires exactly to specified requirements. In the case of the individualized information from a total amount of information, the communication network subscriber who is authorized to request services and is provided with an application software and/or hardware can, given use of the application software and/or hardware, determine exactly which information he/she would like to have and which he/she will dispense with. Furthermore, he/she can determine the way in which the information he requested is presented and the degree of detail of the information.

The present invention also relates to a communication network which has such an application software and/or hardware according to the invention.

What is claimed is:

1. A method of charging for a service produced in a communication network, comprising:
servicing and charging for the service being produced and performed, respectively, using at least one of application software and hardware on a communication unit of a subscriber of the communication network.

2. The method as claimed in claim 1, wherein the service is produced in a subscriber-specific manner.

3. The method as claimed in claim 1, wherein charging for the service is effected in a service-related or service-conforming manner.

4. The method as claimed in claim 1, wherein the communication unit is a communication terminal for a mobile communication device.

5. A computer readable medium having application software stored thereon, the software comprising:
servicing and charging at least one service to be produced and performed, respectively, such that the program is configured to be integrated into a communication network.

6. The application software as claimed in claim 5, wherein the software can be installed on a communication unit of a subscriber of the communication network.

7. The application software as claimed in claim 6, wherein the communication unit is a communication terminal for a mobile communication device.

8. The application software as claimed in 5, wherein the charging can be performed in a service-related manner.

9. The application software as claimed in 5, wherein the service can be produced specifically for a communication network subscriber.

10. A system, comprising:
hardware to service and charge at least one service to be produced and performed, respectively, such that the hardware is configured to be integrated into a communication network.

11. A communication network system, comprising:
at least one of application software and hardware to service and charge at least one service to be produced and performed, respectively, such that at least the application software and hardware are configured to be integrated into a communication network, wherein
the software and hardware are configured for installation on a communication unit of a subscriber of the communication network,
the communication unit is a communication terminal for a mobile communication device,
the charging can be performed in a service-related manner, and
the service can be produced specifically for a communication network subscriber.
